(19) United States
(12) Patent Application Publication
(10) Pub. No.: US 2011/0315023 A1
(43) Pub. Date: Dec. 29, 2011

(54) Three Dimensional Cooking Pad

(75) Inventors: Dimitri Peter Zafiroglu, Centerville, DE (US); Stephen Tsiarkezos, Elkton, MD (US)

(73) Assignee: Xymid, LLC, Midlothian, VA (US)

(21) Appl. No.: 13/165,253

(22) Filed: Jun. 21, 2011

Related U.S. Application Data
(60) Provisional application No. 61/358,680, filed on Jun. 25, 2010.

(51) Int. Cl. A23L 1/01

(52) U.S. Cl. 99/352

(57) ABSTRACT

A cooking pad has a three dimensional surface configuration of peaks and valleys for cooking food. The three dimensional surface configuration elevates the food to a level where it cooks efficiently and evenly. The three dimensional surface configuration rapidly moves liquids expelled from the food during cooking away down depressions and prevents splattering of the liquids back onto the food. The cooking pad may be preformed to the three dimensional surface configuration or may assume this three dimensional surface configuration upon exposure to a cooking environment.

### CROSS-REFERENCE

The present application claims priority to commonly-owned U.S. provisional application 61/358,680 filed on Jun. 25, 2010 under 35 U.S.C. 119(e) and which is incorporated by reference herein its entirety.

### FIELD OF THE INVENTION

This invention relates to cooking pads for foods, such as meat, that forms a three dimensional configuration that elevates the food and/or rapidly draws-off fluids such as fat and meat juices from the cooking food. The pad may be pre-formed with the three dimensional surface configuration or adopt the three dimensional surface configuration upon exposure to a cooking environment. The invention also relates to ready-to-cook packaged foods, such as microwave ready food products that incorporate the cooking pads of the present invention.

### BACKGROUND OF THE INVENTION

The increased consumption of prepared microwaveable foods has lead to an increased demand for improved microwaveable packages. These prepared foods are commonly sealed in microwave-transparent materials so that people can conveniently cook or heat the foods in a microwave oven without taking them out of the package. However, certain foods, such as bacon, sausages, hamburgers, and thin meat slices, tend to expel a large amount of liquid, such as grease and moisture, during the cooking process. This liquid splatters and/or accumulates at the bottom of the package. This creates messy spills that may injure or soil the user, especially in the case of heated oils, and may also pose a potential health concern given that the expelled grease may accumulate on the surface of the cooked food.

Previous attempts to address the problems associated with cooking these foods have focused on multi-ply cooking pads, such as those disclosed in U.S. Pat. No. 4,935,276 to Pawlowski et al., U.S. Pat. No. 4,950,524 to Hacker, U.S. Pat. No. 5,093,176 to Proibionic et al., and U.S. Pat. No. 5,096,722 to Bair. In general, these references disclose cooking pads with a flat porous top-layer in contact with the food product, an absorbent layer for absorbing the grease and moisture released from the cooked food and optionally bottom or stiffening layers to prevent the leakage of the oil and moisture from the pad or stiffen the pad, respectively. These pads all have flat surfaces that permit the food to remain in contact with the expelled greases and moisture.

U.S. Pat. No. 5,041,325 to Larson et al. discloses a hydrophobic pad capable of absorbing the melted grease in the food when it is cooked. The pad is made from polypropylene and poly-4-methylpentene-1 so that the pad has a network of compact high density regions and pillowed low density regions that form a field of generally dome-like members on the apexes of which the food is supported. The height of these domes is about 0.32 centimeters (⅛ inch). Similarly, U.S. Pat. No. 7,141,770 to Zafiroglu et al. discloses a two-layer absorbent pad to be used in microwaveable packages. The pad has a rigid shrink-resistant face layer and an absorbent body layer beneath the face layer. The face layer may be embossed to provide a surface relief for the purposes of enhancing the rigidity of the face layer, and alternatively, Zafiroglu discloses embossing through the thickness of the pad to increase resistance to shrinking. The depth of the embossment is 0.3 centimeters (⅛ inch) and the depth does not exceed the thickness of the pad.

While the above-mentioned systems fulfill their particular objectives, food adhesion to the pads still exists and is not fully addressed. The surfaces are either flat which maintains maximum contact with the food or the surface depressions are not large or deep enough to keep absorbed liquids away from the food surface. There is also a need to quickly transfer the liquid to the bottom of the pad to avoid accumulation and splatter.

Another well known problem with microwave cooking is that the cooking is not uniform with the middle of the food often being heated more slowly than the periphery of the food. Cooking is also more intense above the floor of the microwave oven than on the floor of the oven. When a microwaveable package is used, cupping of the package, which occurs when the package is inflated, may cause the ends of the food at the edges of the package to be elevated exacerbating the uneven cooking of the food, see e.g. FIGS. 6A and 6B. This is particularly detrimental in cooking foods like bacon in which crispness is often sacrificed when it is microwaved.

Therefore, a need exists for a cooking pad that elevates the food for uniform and efficient cooking, preferably in a microwave oven. Further a need still exists for an absorbent cooking pad that removes expelled liquid quickly from food during cooking and has minimal contact with the food to achieve fast release of the cooked food.

### SUMMARY OF THE INVENTION

The present invention concerns a cooking pad capable of elevating a food off of the cooking surface so that it cooks evenly and efficiently. In a first embodiment of the invention the cooking pad is capable of absorbing cooking fluids. The cooking pad has a top and a bottom, a thickness and is made of an absorbent layer that has a top and bottom and forms a three dimensional configuration comprised of one or more peaks and valleys. The height of the three dimensional configuration of the absorbent pad, measured by the vertical distance from one peak to the bottom of the cooking pad, is greater than the thickness of the cooking pad. Preferably, the height of the three dimensional surface configuration is at least about ⅝ inch. Another embodiment of the invention provides that the depth of the valleys, as measured by the vertical distance between one peak and its adjoining valley, is greater than the thickness of the cooking pad. In this embodiment it is preferred that the depth of the valley be greater than a ½ inch. A further embodiment provides that the horizontal distance from peak to peak on the three dimensional configuration be greater than 1.0 inch. Optionally, a non-stick layer may be attached to top of the absorbent layer of the cooking pad. This cooking layer may be foraminous and is preferably made of a silicon-coated paper. Alternatively, the non-stick layer may be a foraminous coating applied to the top of the absorbent layer. A substantially liquid impermeable layer may also be attached to the bottom of the absorbent pad.

In another embodiment, the absorbent layer of the inventive cooking pad assumes a three dimensional configuration in response to a cooking environment. In one example of this embodiment a dimensionally alterable member is attached to the absorbent pad. The dimensionally alterable member may be a shrinkable element or an expandable element. In those embodiments where the dimensionally alterable member is a shrinkable element, preferably the shrinkable element is responsive to heat. The shrinkable element may be either continuous or discontinuous, and where the shrinkable element is discontinuous the elements may be partially oriented yarns. In another embodiment, the dimensionally alterable member may be an expandable element such as an inflatable pouch. A further embodiment provides that the absorbent pad is placed over a separate bulkable layer which assumes a three-dimensional configuration in response to a cooking environment.

In a further embodiment the cooking pad is transformable. The cooking pad has a substantially flat layer with a top, bottom, and thickness with a dimensionally alterable member attached to the layer. The dimensionally alterable member alters its dimensions upon cooking such that the layer forms a three dimensional configuration. Preferably, the dimensionally alterable member is attached to the top of the layer and the food to be cooked is placed on top of the dimensionally alterable member. In this embodiment, the dimensionally alterable member only has discreet lines or points of contact with the food upon the layer assuming a three dimensional configuration. In another embodiment, the dimensionally alterable member may be a web or net. In a further embodiment, the three dimensional configuration is a bowl, and the food to be cooked may be suspended above the bowl by the dimensionally alterable member.

The above-noted embodiments of the inventive cooking pad may be incorporated into a microwaveable pouch and used as a microwaveable package. The food to be cooked may be pre-packaged in the microwaveable pouch or be inserted by the user of the microwaveable package prior to cooking. In preferred embodiments, the food to be cooked is a meat and more preferably bacon.

### BRIEF DESCRIPTION OF THE DRAWINGS

FIG. 1 is a section view of a three dimensional absorbent cooking pad according to one embodiment of this invention.

FIG. 2A is a section view of a three dimensional absorbent cooking pad according to one embodiment of this invention prior to being exposed to a heat source.

FIG. 2B is a section view of the three dimensional absorbent cooking pad of FIG. 2A upon being exposed to a heat source.

FIG. 3 is a section view of a three dimensional absorbent cooking pad according to one embodiment of this invention in which the high and low areas of the pad extend in one direction across the length of the pad.

FIG. 4 is a section view of a three dimensional absorbent cooking pad according to one embodiment of this invention in which the high and low areas of the pad extend in two directions, along and across the length of the pad.

FIG. 5A is a top- and cross-section view of a three dimensional absorbent cooking pad according to this invention wherein the high and low areas of the pad are specially arranged in order to raise the center of the pad more than the periphery.

FIG. 5B is a top- and cross-section view of the pad of FIG. 5A after exposure to heat.

FIG. 6A is a section view of a prior art microwave cooking packaging system prior to being exposed to a heat source.

FIG. 6B is a section view of a prior art microwave cooking packaging system after being exposed to a heat source.

FIG. 7 is a section view of a microwave cooking packaging system according to one embodiment of this invention after being exposed to a heat source.

FIG. 8A is a top view and cross-section view of a pad of this invention encompassing shrinkable strips of material attached at intermittent points to the absorbent pad.

FIG. 8B is a top and cross section view of the pad of FIG. 8A after being exposed to a heat source.

FIG. 9A is a top- and cross-section view of a pad of this invention wherein shrinkable weft inserted yarns are laid under the pad and held at points by intersecting chain stitches formed with non shrinkable yarns.

FIG. 9B is a top- and cross-section view of the pad of FIG. 9A after exposure to heat.

FIG. 10A is a top and cross sectional view of a pad of this invention, wherein the pad has been stitched with spaced-apart rows of chain stitches of non-shrinkable yarns holding zig-zag laid-in shrinkable yarns.

FIG. 10B is a top- and cross-section view of the pad of FIG. 10A after exposure to heat.

FIG. 11A is a top- and cross-section view of a pad of this invention stitched with spaced-apart rows of shrinkable yarns.

FIG. 11B is a top- and cross-section view of the pad of FIG. 11A after exposure to heat.

FIG. 12A is a top- and cross-section view of a pad of this invention stitched with spaced-apart diagonal intersecting lines of stitches formed with shrinkable yarns.

FIG. 12B is a top- and cross-section view of the pad of FIG. 12A after exposure to heat.

FIG. 13A illustrates the use of a secondary pouch placed under the absorbent pad according to another embodiment of this invention.

FIG. 13B illustrates the assembly of FIG. 13A subjected to microwave heating.

FIG. 14A illustrates a variation of the set-up of FIG. 13B with the secondary pouch being tricameral.

FIG. 14B illustrates another variation of the set-up of FIG. 13B wherein the secondary pouch is integrated into the primary pouch.

FIG. 15A is a top- and cross-section view of a pad of this invention with discontinuous shrinkable strips attached to the top of the absorbent pad.

FIG. 15B is a top- and cross-section view of the pad of FIG. 15A after exposure to heat

FIG. 16A is an illustration of another embodiment of a pad of this invention with discontinuous shrinkable strips attached to the top of the absorbent pad.

FIG. 16B is an illustration of the pad of FIG. 16A after exposure to heat.

FIG. 16C is an illustration of the pad of FIG. 16B where the discontinuous shrinkable element is a net.

FIG. 17A is a top- and cross-section view of a pad of this invention with a discontinuous shrinkable grid attached to the top of a pad intended to form a bowl.

FIG. 17B is a top- and cross-section view of the pad of FIG. 17A after exposure to heat.

### DETAILED DESCRIPTION OF THE INVENTION

This invention concerns a disposable structure that forms a three dimensional configuration. This configuration facilitates the cooking of foods by elevating the food during cooking, and/or by rapidly drawing off fluids exuded from the cooking food such as oil, grease, fat, meat juices and the like. Preferably the structure is a composite structure, such as a pad, having layer/layers of material, preferably absorbent, and, optionally a top layer with a non-stick surface, and/or a bottom layer capable of preventing the seepage of cooking liquids from the pad to the cooking surface or consumer's hands.

The invention further relates to a disposable cooking pad that assumes a three dimensional shape upon exposure to a cooking environment. The cooking pad of this embodiment is made with a layer/layers, which are preferably absorbent, with an optional nonstick top layer and/or substantially liquid impermeable bottom layer, which assume a three-dimensional configuration upon exposure to a cooking environment. This change in configuration is due to a dimensionally alterable member to which the absorbent layer is attached or overlaid. Dimensionally alterable members may consist of shrinkable elements and expandable elements. The shrinkable elements may comprise a continuous element such as a shrinkable sub-layer or a discontinuous element such as shrinkable strips or yarns, or a network of shrinkable strips or yarns. The expandable elements may comprise pouches, pockets, or balloons. Upon heating the shrinkable and/or expandable elements cause the absorbent layer to assume a three-dimensional configuration. These elements may also be attached to a separate non-shrinkable layer which assumes a three-dimensional shape in response to the changes in dimensionally alterable member due to the cooking environment and elevates the overlaid absorbent pad. The invention further relates to prepackaged ready-to-cook foods, such as microwave-transparent pouches, having one of the above-noted cooking pads, preferably in contact with the cooking food. The above-noted cooking pads provide three dimensional support for the food that elevates the food to a level at which it cooks more efficiently and evenly and provides for the rapid removal of fluids emanating from the food.

This invention is primarily intended for disposable cooking systems. That is, the product is mainly targeted to single-use applications in which prepared, cooked (fully or partially) or uncooked food is placed on the cooking pad or in a prepackaged system. When the cooking pad or prepackaged food is placed in the cooking environment, such as a microwave oven, the food is exposed to the cooking environment to cook it. The cooking pad or prepackaged food is removed from the cooking environment, and the cooked food is then removed therefrom and the pad or packaging is disposed. However, it will be appreciated that the pads and prepackaged systems of the present invention may be adopted for permanent and re-usable cooking systems. For example, in one embodiment, the non-stick top layer may be a reusable structure having the three dimensional surface configuration with which disposable absorbent layers may be combined prior to cooking.

The primary application for this invention is pre-packaged, typically frozen or refrigerated foods that are distributed to the consumer within a sealed pouch impervious to liquid and gas transfer in which the food is positioned in contact with the cooking pad. These foods can be uncooked, partially cooked, or fully cooked when sealed within the package by the manufacturer or distributor. Although, the cooking of a variety of foods will benefit from the cooking pads of the current invention, the cooking of foods, such as meats, that tend to exude a large amount of liquids during cooking will be particularly benefited. Specifically, meats such as bacon, sausages, and hamburgers will benefit from the cooking pads of the current invention as the pads will quickly draw off cooking liquids such as grease that will tend to splatter and suitably position the foods such that they will be cooked uniformly.

It will be readily appreciated that the materials discussed in the embodiments below are suitable for their intended purpose. Thus, if a cooking pad is intended for use within a particular cooking environment or with a particular food, the materials used to make the cooking pad should be suitable for that use. For example, if a pad is intended for use within a microwave oven, the materials used to manufacture that item should be microwaveable transparent, i.e. the materials should not significantly interfere with or otherwise affect microwave radiation and that the materials are themselves not adversely affected by the amounts of microwave radiation used in cooking foods. Further, the materials should have a melting point greater than about 450° F. (232° C.), so that the materials do not liquefy or substantially soften/melt during the cooking process. Although microwave ready foods may benefit from the inventive cooking pads, the pads can be used in other cooking environments as well including, but not limited to, conventional ovens, convection ovens, infrared ovens, reflector or solar ovens, and wood burning ovens (black or white) and other cooking devices such as slow cookers and pressure cookers.

Also, since the cooking pads of the current invention are intended for use with foods, the materials for making the cooking pads preferably should meet the standards for use with such food products as set forth by the appropriate governmental regulatory authority, e.g., those of the Department of Agriculture (USDA) and the Food and Drug Administration (FDA) within the United States. In particular, it is preferred that the materials do not use additives and finishes, but if such additives or finishes are needed, only substances approved for use with foods by the USDA, FDA or the equivalent governmental regulatory authority outside the United Stated should be used.

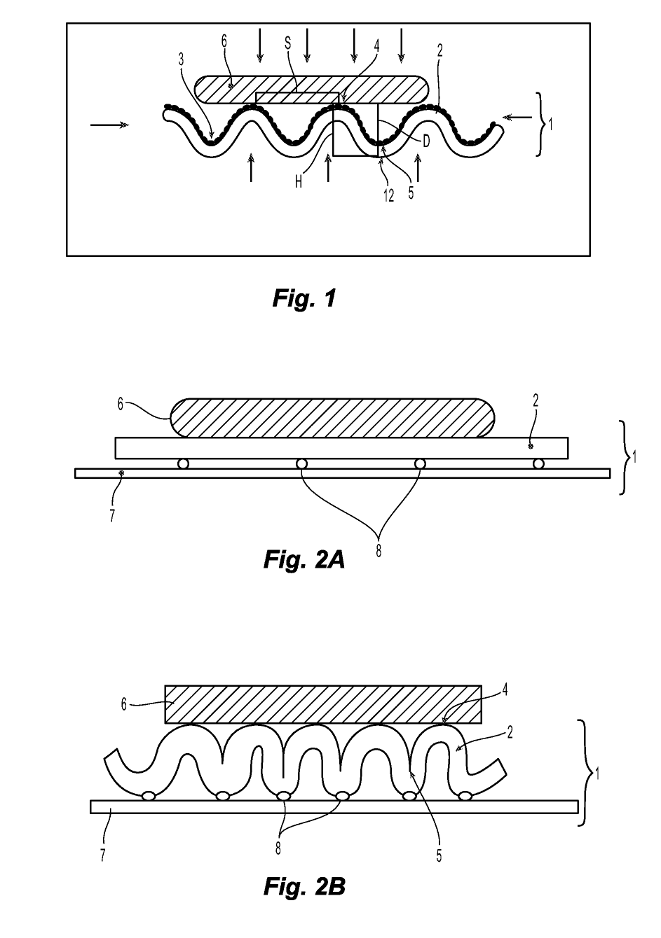

The invention can be understood with reference to the figures. FIG. 1 illustrates a section view of an embodiment of the cooking pad 1 of the current invention. In FIG. 1 a food item 6 is supported by cooking pad 1 which in this particular embodiment has a top layer 3 and an absorbent layer 2 in a three dimensional configuration.

Cooking pad 1 may consist solely of one or more of absorbent layer 2 which are molded into a three dimensional configuration. Absorbent layer 2 usually has an open structure consistent with its primary purpose of absorbing and retaining the liquids expelled from the cooked food. Typically, absorbent layer 2 comprises fibers, fibrils, pulps or foams, and may be made of cellulosic or polymeric materials. Representative materials include, but are not limited to, polyester felts, as described in the aforementioned '722 patent, Kraft paper, non-woven cellulosic pads, resin bonded paper products, and open cell foams. Further, the absorbent material selected for absorbent layer 2 should have sufficient strength and rigidity to avoid crumpling, gathering, buckling and the like under the weight of food 6 and under the effects of the cooking environment, i.e. exposure to heat, radiation, and/or infrared, duration of cooking, etc. Typical structural factors that can affect the rigidity of the absorbent layer include thickness, basis weight, and/or density of absorbent layer 2. The thickness of absorbent layer 2 is between about 2 to 6 mm, preferably between about 2.5 to 5.5 mm, and most preferably between about 3 and 5 mm. Additionally, absorbent materials used for the absorbent layer 2 have a basis weight in the range of 50 to 300 gms/sq m and a density of about 0.02 to 0.20, preferably about 0.04 to 0.10 gms/cc.

Optionally, absorbent layer 2 may be reinforced using stiffening members including, but not limited to, polymeric strands or rods, and stiff open mesh. The reinforcement elements should be suitable for the cooking environment the cooking pad will be used in. For example if the pad is intended for use in a microwave, the reinforcement elements should be transparent to, and unaffected by microwave cooking radiation and able to withstand the temperatures of microwave cooking. If absorbent layer 2 is comprised of multiple layers each layer may be comprised of the same absorbent materials or may have differing absorbent materials. For example, where absorbent layer 2 is comprised of several layers, the layers having greater densities may be layered at the bottom, furthest from the food, to provide additional strength to the three dimensional surface structure without interfering with the absorbent abilities of absorbent layer 2. Additionally, the multiple layers may be attached to one another using conventional methods of attachment such as adhesive or ultrasonic bonding, thermal bonding, stitching, stapling, calendering, laminating, and/or embossing provided that the adhesive component or method is able to withstand the cooking temperatures, does not contaminate the food, and/or does not interfere with the absorbent qualities of absorbent layer 2.

Optionally, cooking pad 1 may also include a non-stick top layer 3. Non-stick top layer 3 may or may not be made of fibrous cellulosic or polymeric materials coated with a non-stick agent, provided that the layer is effectively porous to permit the exuded liquids from the food to be absorbed into absorbent layer 2. Further, to the extent that materials contemplated for non-stick top layer 3 are too dense to permit the passage of the exuded liquids to absorbent layer 2, the materials may be perforated, hole punched, slit or otherwise made foraminous. Many structures are contemplated such as perforated film or paper; grids; screens; and woven, knit or non-woven fabrics, including meshes, screens, and nets. Spunbonded polyester or polyurethane nonwovens (e.g. Reemay™ synthetic fabrics) free of finishes that decompose at about 50° F. are effective. Perforated polyester or polyurethane films or papers or slit film warps that may be woven or bonded without the use of finishes are also suitable. Additionally, in cooking environments other than microwave ovens metal structures including but not limited to, perforated metal sheets, wires, screens, and grids are contemplated as well. Further, non-stick top layer 3 may be configured as a reusable cooking surface such as a mesh or screen configured in a three dimensional configuration and absorbent layer 2 can be assembled underneath the non-stick top layer 3 prior to cooking.

As noted above, these materials are coated with a non-stick agent or release agent that is approved for use with foods. Examples of such agents include, but are not limited to, TEFLON™, silicon, oils, fats, greases, waxes, and lechthins. In a preferred embodiment, the non-stick top layer is a silicon-coated paper. Non-stick top layer 3 may be bound to absorbent layer 2 using the conventional adhesive methods noted above. Alternatively, non-stick top layer 3 may consist of a foraminous coating of a non-stick agent or release agent directly onto absorbent layer 2 so long as the coating does not disrupt the ability of absorbent layer 2 to absorb the expelled liquids from the food. In a further embodiment of the current invention, the non-stick agent coated on the absorbent pad may be a fat, grease, or oil traditionally used in cooking. These coatings may be applied not only to reduce the likelihood that the food will stick to the absorbent pad but also to impart or enhance the flavor of the food. The cooking oils, fats, and greases may be supplemented by natural, nature-identical, and artificial flavoring substances such as herbs, flavorings (such as vanilla, almond, liquid smoke), savory flavorants (such as glutamic acid salts, glycine salts, guanylic acid salts, inosinic acid salts, 5′ribonucleotide salts), and/or esters (such as diacetyl (butter smell), cinnamic aldehyde (cinnamon smell), ally hexanoate (pineapple smell)). For example, a cooking pad of the current invention may be used to cook a chicken breast and the absorbent pad could be coated with butter and a lemon flavoring as a non-stick foraminous coating to impart those flavors to the cooking chicken breast.

Further, a bottom layer, not depicted in FIG. 1, may optionally be added to cooking pad 2 to provide a substantially fluid impermeable base so that the exuded cooking liquids do not penetrate absorbent layer 2 and soil the cooking appliance, the user, or any additional surfaces cooking pad 1 may be placed on following cooking. Additionally, this backing may prevent inadvertent injuries to the user by exposure to heated oils or grease on the bottom of cooking pad 1. Any substantially fluid impermeable cellulosic or polymeric material including, but not limited to, wax coated papers may be used for the substantially fluid impermeable bottom layer.

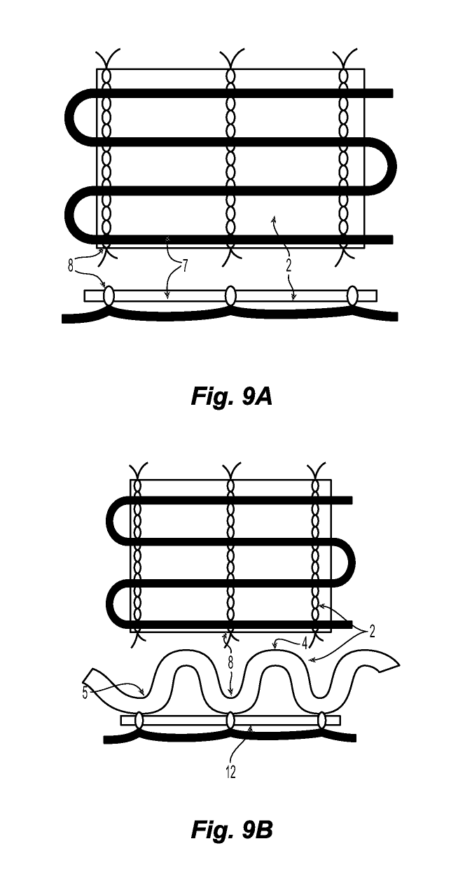

The overall thickness, T as shown in FIG. 8A, of cooking pad 1, inclusive of absorbent layer/layers with optional top and bottom layers, is about 3 mm (12 inches) to about 50 mm (2.0 inches).

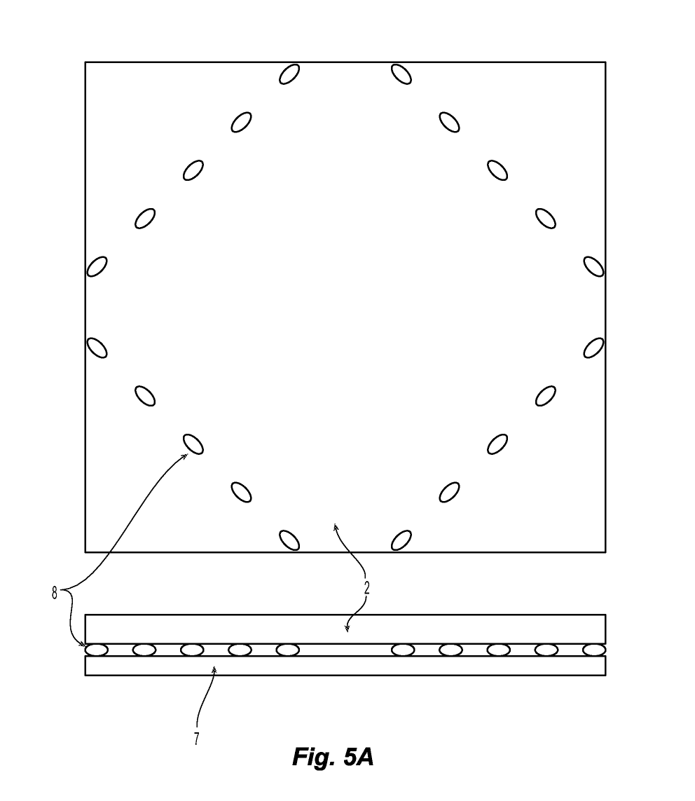

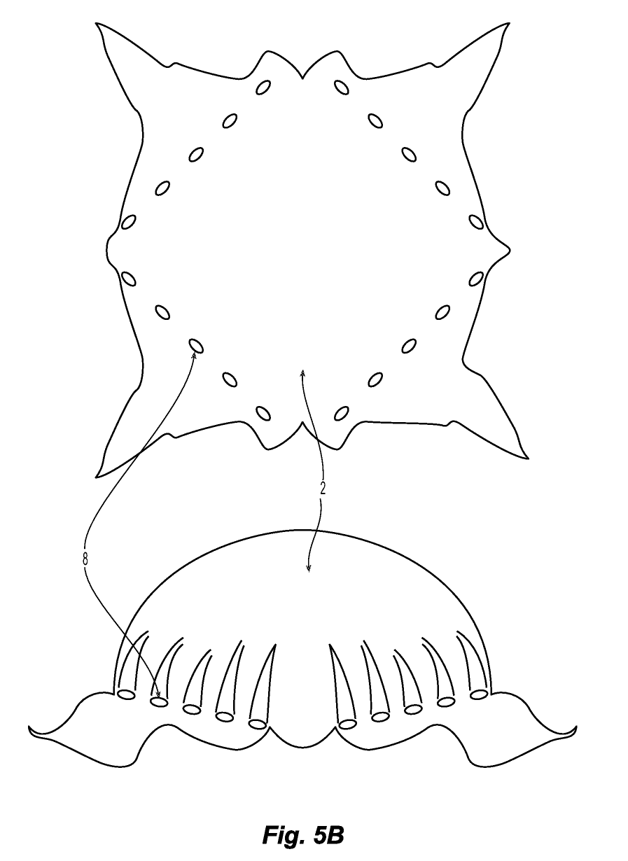

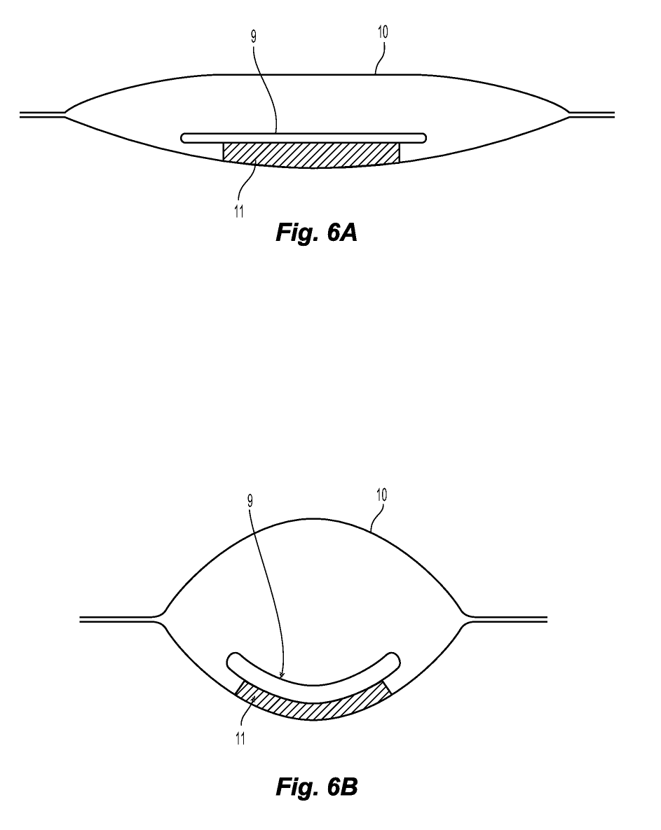

The three dimensional configuration of cooking pad 1 sufficiently elevates food 6 off of the cooking surface of the cooking appliance, such as the tray, shelf, etc. within conventional and/or microwave ovens, so as to provide even cooking of the food and to prevent the spattering of expelled liquids back onto the cooking food. This is accomplished by holding food 6 on elevated areas such as peak 4, which alternatively may be referred to as a ridge, dome or elevation, adjacent to depressed areas such as valley 5, which alternatively may be referred to as a bottom or depression, as illustrated in FIG. 1. This configuration permits the rapid drainage of cooking fluids away from the cooked food into the valley, where they collect at a distance far enough removed from the food to prevent spattering. The peaks and valleys may extend in one direction, in which case the three dimensional surface configuration may take the form of a series of parallel ridges aligned along the width or length of the pad or may be oriented diagonally across the face of the pad, FIG. 3. The peaks and valleys may extend in two directions, in which case the three dimensional surface configuration may also consist of isolated peaks or domes along the face of the pad generating an “egg crate” configuration, FIG. 4. Further the peaks may be designed so that they are strategically placed to elevate the middle of the pad as illustrated in FIGS. 5A and B. Alternatively, the peaks and bases may be randomly oriented for the purpose of forming a three dimensional surface configuration that is a fanciful design such as an image, trademark, or text.

In this embodiment, the height of the peaks is greater than the thickness of cooking pad 1. The height H, determined from base 12 to the peak 4 as illustrated in FIG. 1, may be at least about ⅜ of an inch (9.52 mm). Alternatively, the height H may be between about ⅜ inch (9.52 mm) and about 1½ inches (38 mm). Furthermore, it is preferable that the depth D of valley 5, measured from peak 4 to valley 5 as illustrated in FIG. 1, is greater than thickness T of the cooking pad as well. The depth D may be greater than about ⅛ inch (3.17 mm). Additionally, the surface distances S, measured from one peak to an adjacent peak as illustrated in FIG. 1, may be at least about ½ inch (12.7 mm), more preferably the distance is about ⅝ of an inch (15.86 mm), and most preferably is significantly larger than about ¾ of an inch (19.05 mm). Height H and surface distance S between the peaks may be uniform across the pad. However, the height of peaks H and surface distance between peaks S may be adjusted to suit particular needs. For example, peaks located at the ends of the cooking pad 1 may be less than the height of the peaks within the middle of the pad to counteract any cupping that may occur when the pad is used in a microwaveable food package. Alternatively, the peaks may be spaced more closely together across the middle of cooking pad 1 if a heavier food item is being cooked. Cooking pad 1 may be formed into the three dimensional configuration using conventional methods of molding non-woven fabrics such as compression molding (heat and pressure molding) thermosetting molding or embossing. Cooking pad 1 may be molded after its various layers have been assembled and bonded or the individual layers may be molded and then bound together afterwards to complete cooking pad 1.

Another embodiment of the current invention is a cooking pad that assumes a three dimensional configuration upon exposure to the cooking environment. Generally, the cooking pads of this embodiment have an initially flat absorbent layer/layers, optionally with a non-stick top layer and/or a substantially fluid impermeable bottom layer, attached to or laid over a dimensionally alterable member. Where the cooking pad includes a substantially fluid impermeable bottom layer, the dimensionally alterable member may be attached to the substantially fluid impermeable bottom layer and/or to both the absorbent layer and the substantially fluid impermeable bottom layer. A dimensionally alterable member may consist of any component that changes its dimensions (length, width, height, volume, etc.) in response to a cooking environment (heat, humidity, pressure, and or exposure to microwaves or infrared associated with a particular cooking method). In particular, dimensionally alterable members may consist of elements that shrink or expand in response to the cooking environment. Cooking pads of this embodiment have the advantage of being able to be assembled, shipped, and stored in a flat configuration prior to its use thereby reducing many costs (storage, shipping, etc.) associated with bulkier food products. These embodiments are useful in microwaveable food products where ease of assembly, packaging, shipping and storage are important considerations.

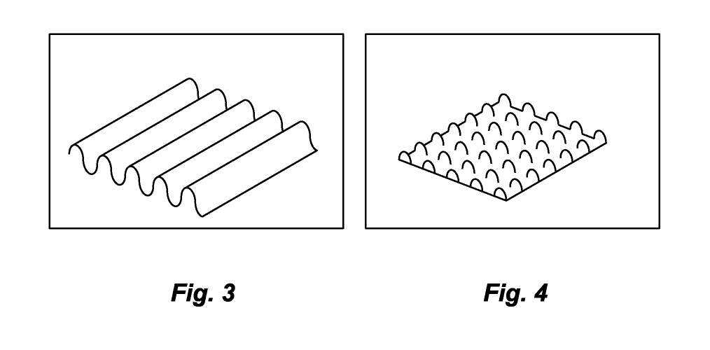

FIGS. 2A and 2B illustrate a particular example of this embodiment of the current invention related to the use of shrinkable elements. FIG. 2A illustrates cooking pad 1 prior to heating. Cooking pad 1 has a flat absorbent layer 2 made of similar materials as discussed above bonded at connection points 8 to a shrinkable element 7. FIG. 2B demonstrates that upon heating cooking pad 1 assumes a three dimensional configuration as shrinkable element 7 shrinks in response to the heat. This causes absorbent layer 2 to compress and/or buckle forming the three dimensional surface configuration which elevates the food and generates peaks 4 and valleys 5 for drawing off the cooking liquids. The height of the peaks 4 and depth of the valleys 5 formed by the embodiments of cooking pad 1 involving the dimensionally alterable member may be of sufficient height and depth to elevate the food to a level where it is efficiently cooked and/or provide depressions that effectively draw off the exuded cooking liquids. The heights of the peaks 4 and depths of the valleys 5 may have the dimensions recited above in paragraph [0057] but need not so long as they achieve the stated objectives.

Shrinkable element 7 may be continuous, such as a shrinkable sub-layer of a plastic film, woven or nonwoven fabric, or foam. It can also be discontinuous, such as an array of shrinkable film or fabric strips or partially oriented (POY) yarns.

FIGS. 2A and 2B show a shrinkable element 7 that is a continuous shrinkable sub-layer. These shrinkable sub-layers may comprise cross-linked and cold-drawn plastic (polymeric) films that deform (shrink) upon being exposed to a cooking environment. In particular, heat shrinkable plastics are known in the art. Suitable shrinkable polymeric films may be made from polyolefin films, such as, polyethylene films, including low density polyethylene films, linear low density polyethylene films, very low density polyethylene films and polyethyleneterephthalate, and polyester films such as aliphatic polyesters; ethylene vinyl acetate; ethylene vinyl alcohol; polyvinyl chloride; polylactic acid and/or blends or combinations thereof. See U.S Patent Publication No. 20090227735, PCT Publication No. WO 20030084871, and U.S. Pat. Nos. 4,966,805 and 5,397,640, hereby incorporated by reference in their entirety. Additionally, shrinkable woven or nonwoven fabrics made of partially oriented yarns, including those disclosed below, may be used for the shrinkable sub-layer. Similarly a layer of heat shrinkable foam manufactured from the above-noted polymers and styrene polymers may be used as well. Shrinkable sub-layers may be unidirectional, upon heating the layer shrinks in a single direction (either length or width wise), or bidirectional, upon heating the layer shrinks in two directions (length and width wise).

As noted above, shrinkable element 7 may be discontinuous, such as an array of shrinkable film or fabric strips or partially oriented (POY) yarns as shown in FIGS. 8A and 8B. Partially oriented yarns are known in the art and may be made of polyolefins including, but not limited to, poly(trimethylene terephthalate), poly(ethylene terephthalate), and polyamides (such as Nylon 66). Such yarns are disclosed in U.S. Pat. Nos. 5,879,779 and 6,407,018 B1, hereby incorporated by reference in their entirety.

Further, it is preferred that the shrinkable element should begin to shrink before reaching the cooking temperature of the food so that the cooking pad 1 assumes the three dimensional configuration when the heating element reaches the desired cooking temperature. Thus, for example, if the cooking pad of the present embodiment is used within a microwave oven the shrinkable element should begin to shrink prior to reaching 450° F. (232° C.), the average cooking temperature within microwave ovens. Preferably, the shrinkable element will begin to shrink at a lower temperature, at least by about 325° F. (162° C.) and more preferably below 250° F. (121° C.). However, the shrinkable element should not undergo substantial shrinkage under ambient temperatures or temperatures reached during the storage and shipping of the cooking pads and associated food products. Preferably, the shrinkable element should not substantially shrink at temperatures below about 110° F. (43° C.). A convenient test for shrink is to place a cooking pad 1 utilizing a shrinkable element of interest on a hot plate having a low-friction/easy-release surface (e.g., Teflon™ fluoropolymer coated or covered with a sheet of polytetrafluoroethylene “PTFE” or PTFE-coated glass fabric) heated to 500° F. for one minute. The shrinkable element should shrink more than 20% upon being exposed to the hot plate, preferably more than 30%, more preferably more than 40% and most preferably more than 50%. Additionally, upon being exposed to the hot plate cooking pad 1 should undergo a majority of its deformation nearly instantaneously. Despite the shrinking of the shrinkable element it should not soften or melt to the extent that it fails under the cooking environment and within the average time the prospective food would need to cook.

As noted above, the shrinkable element, continuous or discontinuous, is attached to absorbent layer 2 via connection points 8. In FIGS. 2A and 2B, the shrinkable element 7, the continuous shrinkable sub-layer, is attached to absorbent layer 2 at connection points 8 such that upon being exposed to the cooking environment absorbent layer 2 will buckle and assume the three dimensional surface configuration with peaks 4 and valleys 5. The connection points 8 may be placed linearly, as points and/or lines of attachment, across the width or length of the pad in order to generate parallel rows of peaks and bases as shown in FIG. 3. Alternatively, the connection points 8 may be placed as points and/or lines of attachment across the width and length of the pad to generate a series of isolated peaks or domes, as shown in FIG. 4, on the pad as the peaks and valleys will extend in two directions (length and width wise).

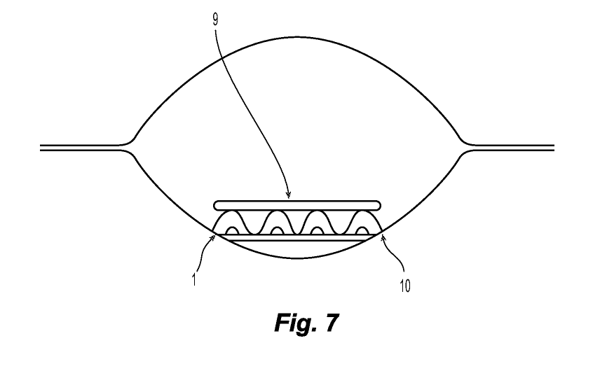

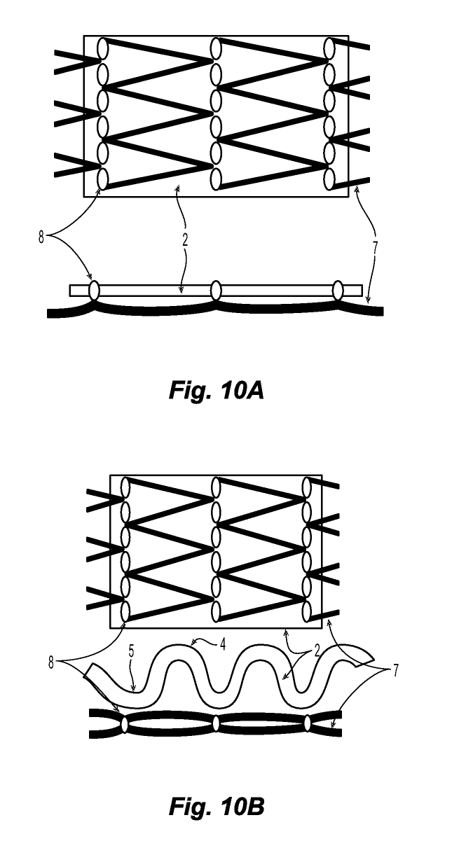

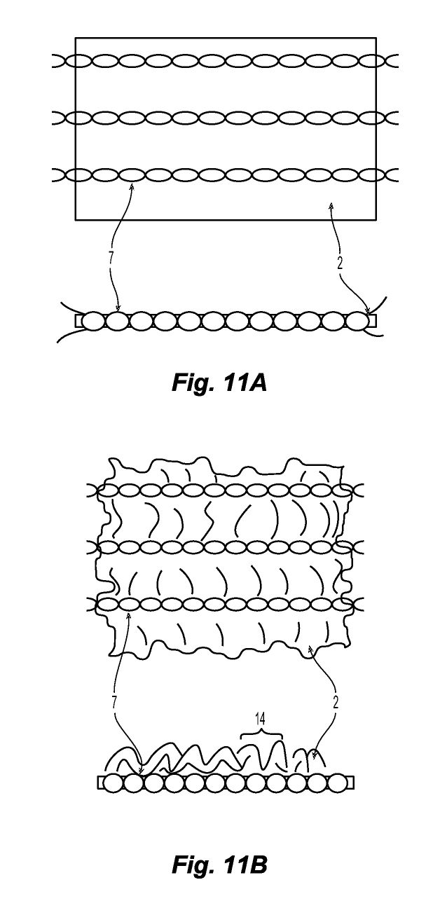

Discontinuous shrinkable elements on the absorbent pad 2 can be arrayed in a rectilinear, curvilinear or zig-zag pattern (not shown). The method of attachment of such arrays includes but is not limited to heat sealing, ultrasonic bonding, sewing, stitching, stapling and the like at the connection points or lines 8. One method of connecting the discontinuous shrinkable elements comprises laying an array of weft-inserted shrinkable yarns onto the backside of the absorbent layer 2 in a stitch bonding machine and to hold them down with nonshrinking stitches, as shown in FIGS. 9A and 9B. Alternately the shrinkable yarns can be placed with a zig-zag pattern within the stitch bonder as shown in FIGS. 10A and 10B. When the discontinuous shrinkable elements are located below the absorbent layer 2 as shown in FIGS. 8, 9 and 10, the bulking of the absorbent layer 2 occurs in a manner similar to that of using a contiguous shrinkable sub-layer, as illustrated in FIGS. 2B and 6.

If points of attachment are used to attach the absorbent layer to the shrinkable sub-layer, the points of attachment could be spaced at uniform intervals or with variable intervals sufficient to achieve the objective of raising the food to a level where it will cook more efficiently. The spacing between attachment points may be at least about ½ inch. Alternatively, the spacing between the attachment points may be about ½ inch (12.7 mm) to 2½ inches (63.5 mm), more preferably about 1 inch (25.4 mm) to 2 inches (50.8 mm) and most preferably more than about 1½ inches (38.1 mm). The shrinkable sub-layer may be attached to absorbent layer 2 using methods of attachment well-known in the art including, but not limited to, heat or pressure bonding, ultrasonic bonding, adhesives, stitching (with shrinkable or non-shrinkable threads or yarns), embossing, calendering, etc. so long as attachment points 8 will be able to withstand the force generated when the shrinkable sub-layer shrinks and applies pressure to absorbent layer 2.

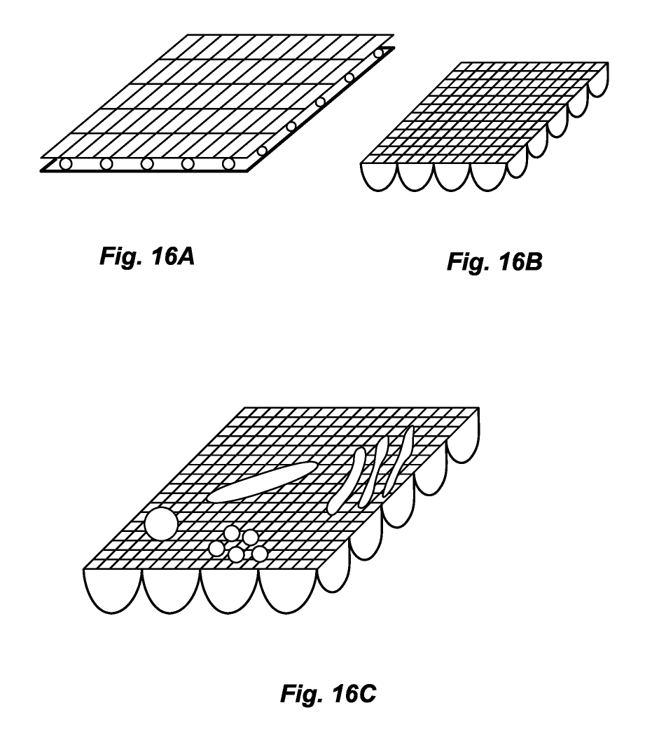

FIGS. 2A and 2B, and FIGS. 8A-10B show a preferred configuration where the shrinkable element is attached to the bottom of absorbent layer 2 (or a substantially fluid impermeable bottom layer if one is included in the pad), side opposite where the food is intended to be placed, however it should be understood that the shrinkable element may alternatively be attached to the top of absorbent layer 2 (or non-absorbent layer if one is included in the pad), same side as the food is intended to be placed. When attached to the top of the absorbent layer 2, it may be preferable to attach the discontinuous shrinkable elements along intended slopes 15 of the three dimensional configuration so that the shrinkable element forces the absorbent layer 2 into the three dimensional configuration without being in contact with the food which is resting on peaks 4, as illustrated in FIGS. 15A-B. In certain instances, it may be beneficial to have the food resting upon the shrinkable element after it has shrunk and forced absorbent layer 2 into the three dimensional configuration such as supporting heavy foods over the valleys 5. It is preferred that a foraminous non-stick coating, such as those disclosed above, is placed over the shrinkable element if it is attached to the top of the absorbent layer. Additionally, as disclosed below, stiffening elements may be useful in embodiments where the shrinkable elements are attached to the top of the absorbent layer to assure that the intended three dimensional shape will be assumed by the absorbent layer.

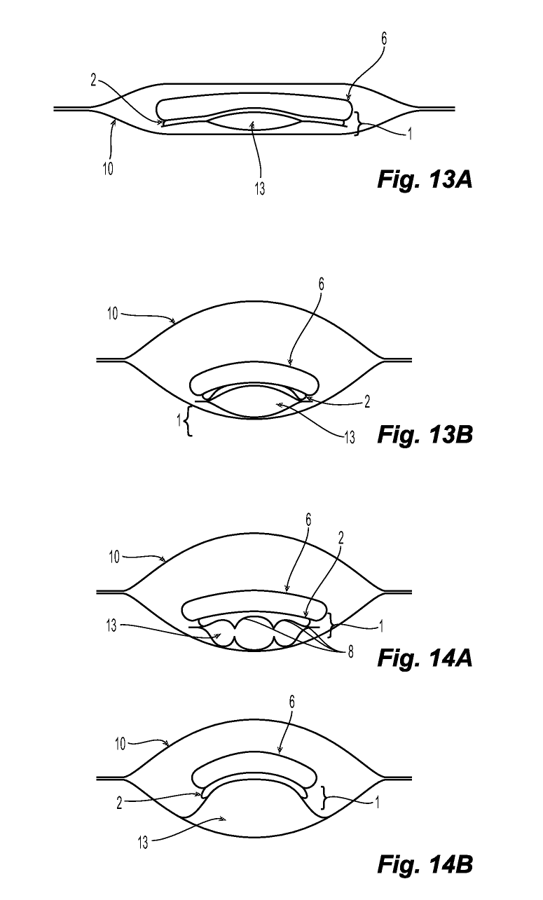

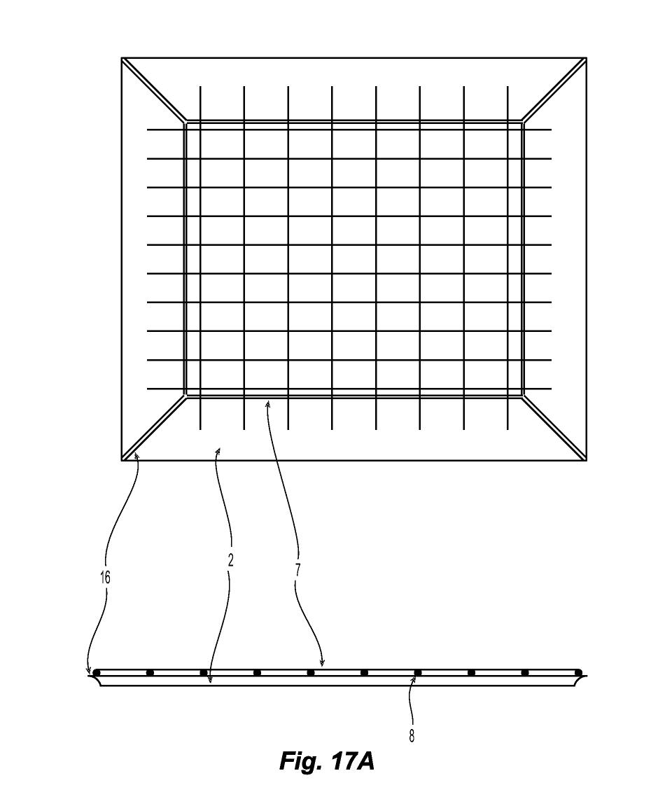

The products of this invention can also be adapted to elevate foods during the cooking process and support them with minimum contact so that heat/hot air and steam can reach all around the food. In this embodiment it is not necessary to have an absorbent pad, but only a pad that can support the food in an elevated position with minimum contact. This embodiment is useful in operations such as steaming vegetables, pasta, and the like, and also in roasting solid/low moisture foods such as grains, cereals or nuts. The pads illustrated in FIGS. 2B, 4, 7, 8B, 9B, 10B, 11B, 12B, 14A, and 15B, can be used for this purpose as shown with the food placed on top, provided that the food is larger than the spacing between the elevated areas. To hold finer foods such as pastas, cereals, grains etc a net-like or fine grid-like surface can be in touch with the food, as in the case of the pads illustrated in FIGS. 8B, 9B, and 10B used “upside-down” with the food resting on the shrunk linear elements or yarns. Alternately a shrinkable net-like layer can be attached to a non-shrinking layer as illustrated in FIG. 16, and the food placed on the shrunk layer.

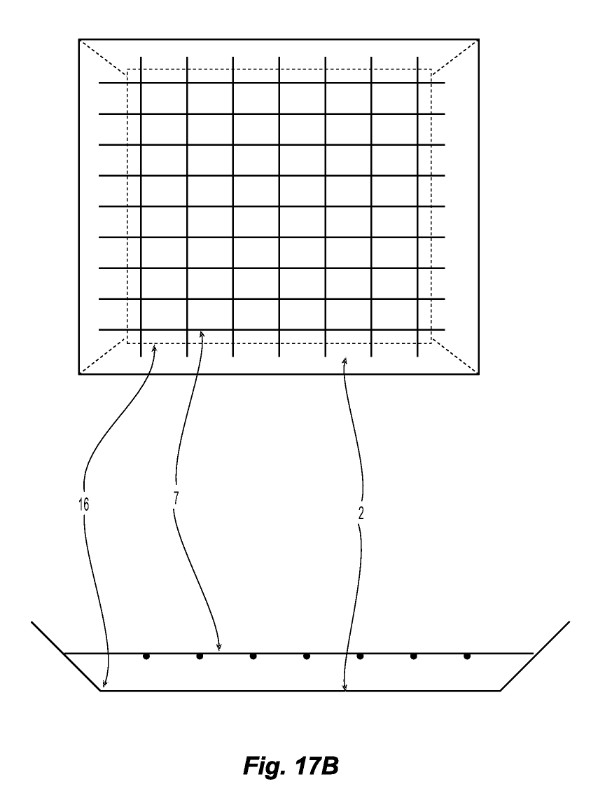

FIGS. 17 A and B illustrate a further variation of the current invention where the dimensionally alterable members are attached to the top of absorbent layer 2. In this embodiment, the absorbent layer and dimensionally alterable members are configured such that the three dimensional configuration of the cooking pad is that of a trough, bowl, cup or similar concave shape. In this configuration, the food is supported by the dimensionally alterable member and suspended over the absorbent pad. This provides the benefit of permitting foods such as pastas and vegetables to be cooked or steamed without those on the bottom becoming soggy and further provides a container in which the food may be consumed after cooking (provided that dimensionally alterable member is removed). Additionally, foods such as popcorn kernels may benefit from a cooking system of this configuration given that the kernels may be suspended at a level where they will cook more effectively and completely resulting in less un-popped kernels and the popped kernels can fall back into the bowl configuration. FIG. 17A illustrates the pad in a flat configuration. Absorbent layer 2 has dimensionally alterable member 7, a web in this instance, attached at attachment points 8 along its periphery. As illustrated in FIG. 17A, the pad may incorporate various support means for guiding the pad into its proper three dimensional configuration, as discussed below, such as crimps 16. Additionally, support members may be incorporated into the pad in the sides and/or bottom of the intended bowl to insure that the proper three dimensional shape is assumed by layer 2 when the force from the shrinking dimensionally alterable member 7 is applied. Further, in the cooking system disclosed below, the pouch may be attached to the edges of layer 2 such that when the microwaveable pouch inflates upon cooking it draws up the edges of the layer and thereby provides a force in addition to that of the shrinking dimensionally alterable member. As shown in FIG. 17B, upon heating dimensionally alterable member 7, the web, shrinks and pulls the sides of the intended bowl into their intended configuration while crimps 16 fold to permit the bowl to form. Optionally, frozen sauces or other flavorings incorporating moisture may be located between layer 2 and dimensionally alterable member 7 so as to provide flavoring and or additional moisture to obtain the desired taste and doneness in the cooked food. For example, when a pasta is the intended food an appropriately sized sheet of frozen sauce may be incorporated between layer 2 and dimensionally alterable member 7. Upon cooking, the sauce will melt and be contained within the bowl generated by the force of the now shrunken dimensionally alterable member 7, as shown in FIG. 17B, providing steam to the pasta suspended above on the shrunken dimensionally alterable member 7. After the pasta is cooked the sauce may be poured from the bowl onto the cooked pasta.

In such embodiments as depicted in FIGS. 15A-17B and disclosed in the preceding paragraphs, absorbent layer 2 may also consist of non-absorbent and/or partially absorbent materials; this is particularly preferable where moisture is necessary to cook/steam the food. Further, in applications where the moisture used to steam or cook the food is not needed after the food is cooked it may be preferable to make the pad of a material that is non-absorbent during a substantial portion of the time the food is cooked and thereafter becomes absorbent. This permits the food to be removed from the cooking pad without the user getting wet and or injured from heated liquids used to cook the food. One means of accomplishing this may to provide an absorbent pad with a foraminous non-stick layer that has a limited number of perforations or holes that are insufficient to permit all of the cooking liquid from passing through and being absorbed during cooking but can absorb the liquids during the rest period following cooking.

As noted above, the current embodiment of the invention assumes a three dimensional surface configuration upon heating. In particular, when shrinkable element 7 shrinks it draws connection points 8 closer to one another putting pressure on absorbent layer 2 causing it to buckle and assume a three dimensional configuration. It may be advantageous to treat or modify absorbent layer 2 so that it buckles in a consistent manner and adopts the desired three dimensional configuration. One means of accomplishing this may be to score, crimp or crease absorbent layer 2 at intended peaks 4 of the three dimensional surface configuration. Additionally, stiffening elements such as those disclosed above may be incorporated into absorbent layer 2 such that the intended slopes of the three dimensional configurations are reinforced and intended peaks 4 and valleys 5 are not, so that the pressure to bend is isolated to those areas. Another means for assuring the desired three dimensional configuration would be to utilize an absorbent layer of varying density where the denser absorptive materials occur along the intended slopes of the three dimensional surface configuration and the less dense materials are utilized along intended peaks 4 of the three dimensional surface configuration.

Alternatively, a density shift in shrinkable element 7 can control the formation of the three dimensional configuration. Specifically, shrinkable element 7 can be manufactured to have strategically placed areas of high density. These areas of high density will not shrink as much as the areas of low density and therefore the buckling and folding of absorbent layer 2 can be controlled. This particular embodiment eliminates the need to intermittently bond shrinkable element 7 to absorbent layer 2 and permits the absorbent layer and the shrinkable element to be bound across their surfaces or laminated to one another or woven and stitched together where the shrinkable element is a strip or yarn.

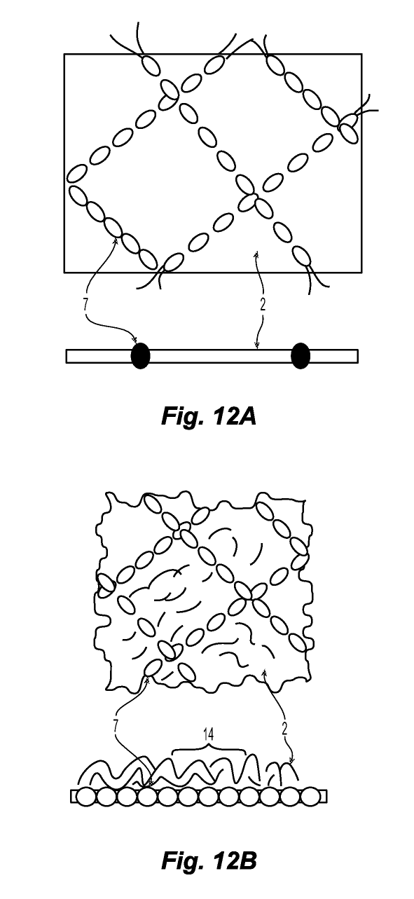

In another embodiment the discontinuous shrinkable elements may be stitched into the absorbent layer, with various patterns of stitches, as illustrated in FIGS. 11 (A-B) and 12 (A-B). In this embodiment the bulking can occur by the formation of “frills” 14 within the unattached areas between the shrinking stitches, as shown. As noted above, the dimensions and rigidity of the frills 14 should be sufficient to elevate the food to a height where it cooks efficiently and the depressions should be deep enough to effectively draw-off exuded cooking liquid. It may be preferable to have the height of the frills 14 be greater than the thickness of the cooking pad 1.

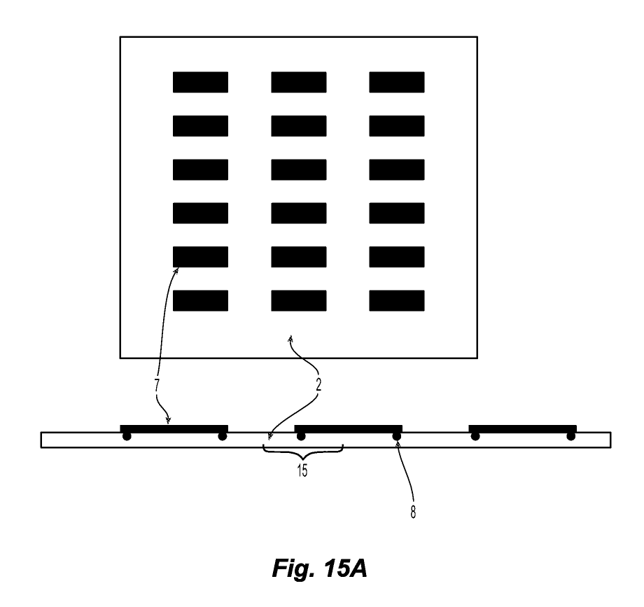

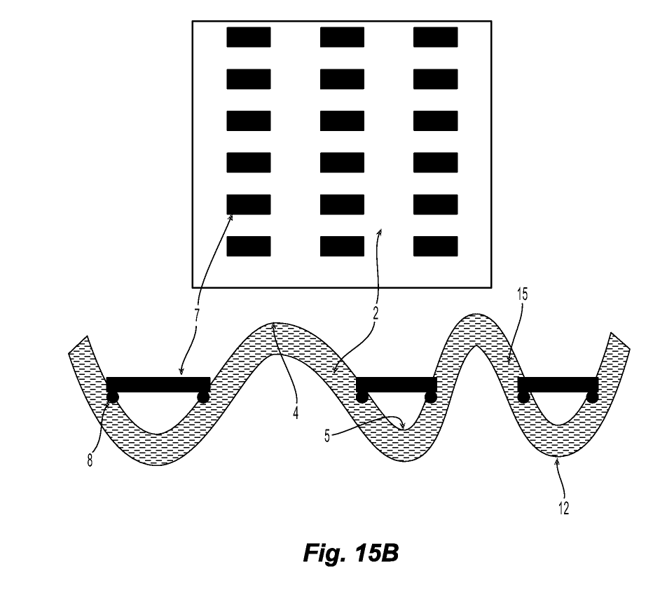

In still another embodiment, the dimensionally alterable member is an expandable element such as a separate pouch, balloon, or pocket that can be placed under absorbent layer 2 during cooking as shown by expandable element 13, a pouch, in FIG. 13A. The expandable element preferably contains moisture (such as water) and will inflate during cooking or may contain discreet elements that expand, foam, or “pop,” similar to popcorn, during heating that expand the volume of the pouch, elevating the food, especially in the middle, as shown in FIG. 13B. The expandable element may consist of a singular pouch or individual pouches, and can be made of materials substantially impermeable to gasses and liquids known in the art to be suitable for cooking. Similar to the shrinkable element disclosed above, expandable element 13 may be attached to absorbent layer 2 via connection points 8, as shown in FIG. 14A. If a singular pouch is used as an expandable element, the points of connection may be used to create depressions similar to the indentations in a decorative pillow or alternatively lines of connection may be used to divide the larger pouch into smaller pouches provided that the moisture and/or discreet expandable elements are sufficiently distributed amongst the divided pouches. Expandable element 13 may be multi-cameral as shown in FIG. 14A, or it may be part of a primary pouch in the cooking system disclosed below, as shown in FIG. 14B.

In a preferred embodiment, even if dimensionally alterable members, shrinkable element 7 or expandable element 13, should fail during the cooking process absorbent layer 2 will maintain the assumed three dimensional surface configurations and its support for the food. Once the pad assumes a three-dimensional configuration the force of the attached dimensionally alterable member is normally not necessary to prevent it from returning to a flat configuration.

In another embodiment a separate bulkable structure, including, but not limited to, stiffening elements or substantially liquid impermeable layers can be used under absorbent layer 2 and this separate bulkable layer will assume a three dimensional configuration in response to the dimensionally alterable member similar to absorbent layer 2 illustrated in FIG. 2B, 8B, 9B, 10B, 11B, 12B, or 13B. This elevates the food during cooking, as in the case wherein the absorbent layer 2 is directly attached and bulked. The absorbent layer may be attached to the bulkable structure or may simply be laid over the bulkable structure.

In the present embodiment, it will be appreciated that cooking pad 1 with dimensionally alterable member, whether expandable or shrinkable element, will shrink in size when the dimensionally alterable member's dimensions change. The cooking pad 1 may shrink in one direction (width or length) or in both directions (width and length). However, the cooking pad 1 should be properly dimensioned such that the food item will be properly supported after being exposed to a cooking environment. For example, if the food item being cooked is a piece of bacon that is 8 inches in length the cooking pad should be at least 4 inches in length after the shrinkable layer has shrunk. Additionally, the pads must be proportioned to fit into the appropriate cooking appliance.

One of ordinary skill in the art will appreciate that one or more of the above noted elements may be combined as a means of generating the three dimensional shape of the cooking pad. For example, expandable elements, such as an inflatable pouch, may be integrated into the cooking pad between the absorbent layer and the shrinkable element and between the points of attachment such that when heated the peaks in the absorbent pad will be formed not only by shrinkable elements but also by the inflation of the expandable element. This particular embodiment has the added benefit that the peaks are supported by the expandable element and therefore heavier foods may be supported by the cooking pad. Further, dimensionally alterable members may be attached to the top and bottom of the absorbent layer to urge the absorbent layer into the desired three dimensional configuration.

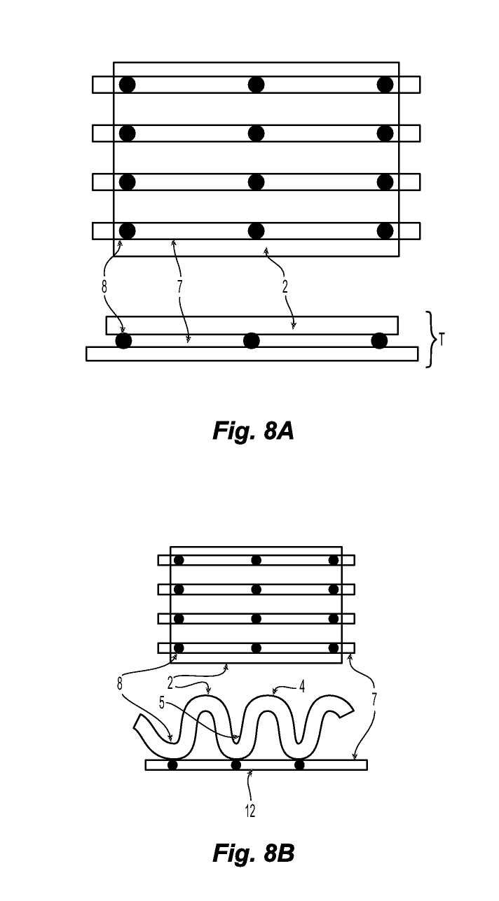

The current invention also addresses the use of the absorbent structures of the current invention in a microwaveable package for a food item such as that disclosed in the '770 patent disclosed above which is hereby incorporated in its entirety. In particular, a food item, such as bacon, supported by the cooking pad of the current invention may be prepackaged in a microwave transparent pouch of a polymer film. As can be seen by FIGS. 6A, 6B and 7, the cooking pad 1 of the present invention provide the additional benefit of protecting against cupping within the microwaveable package. FIGS. 6A and 6B illustrate previous microwaveable packages. Specifically, FIG. 6A illustrates a microwaveable package for bacon 9 wherein bacon 9 and a pad 11 are enclosed within a pouch 10. Upon heating, FIG. 6B shows that the plastic pouch 10 inflates causing the sides of pad 11 to bend upwards and thus the ends of bacon 9. As can be seen in FIG. 7, the three dimensional configuration of the current invention provides the cooking pad 1 with sufficient stiffness to resist the cupping effect of the pouch. A microwaveable package incorporating the current cooking pad can maintain the food on an even and elevated surface leading to even and efficient cooking of the food. In particular, with regard to bacon this leads to more desirable outcomes, such as more evenly cooked and crisper bacon.

Further, in another embodiment a microwaveable package may be provided with foods requiring different cooking methods being separated in individual compartments. The compartments may include the same or different cooking pads of the current invention. This arrangement may permit users to prepare a complete meal at the same time despite the different cooking needs of the component foods. For example, a microwaveable package food for breakfast may consist of two separate compartments: a first compartment including a cooking pad as illustrated in FIG. 7 for cooking bacon; and a second compartment including a cooking pad as illustrated in FIGS. 17A and B for steaming precooked omelets or scrambled eggs. The various embodiments of the pads disclosed above may be enclosed in any combination within the various compartments to achieve the best overall results for the meal. The components preferable are contained within separate sections of microwaveable pouch 10, or alternatively a sheet of material suitable for use in microwaveable pouch 10 may be bound to the periphery of the cooking pads for the individual compartments. In this embodiment a single cooking pad may have sections with dimensionally alterable members arranged in the pattern necessary to form the three dimensional configuration desired to cook the food in that section and then the sheet of material suitable for use in the microwaveable pouch 10 is bound to the pad between each of the sections thereby isolating each of the compartments.

The primary application for this invention is pre-packaged, typically frozen or refrigerated foods that are distributed to the consumer within a sealed pouch impervious to liquid and gas transfer in which the food is positioned in contact with the absorbent pad. These foods can be uncooked, partially cooked or fully cooked when sealed within the package by the distributor. The consumer places the entire sealed pouch with food into an oven in which the food is cooked while inside the pouch. Optionally and as sometimes called for by the distributor's cooking instructions, the consumer will pierce the outer wall of the manufacturer-sealed pouch to permit escape of gases emitted during cooking. In another contemplated application, the consumer can purchase a package system with a sealable pouch and an absorbent pad. The food is purchased separately and independently of this package system. In that case the consumer can insert a food item into the pouch for cooking.

Though specific forms of the invention have been selected in the preceding disclosure for illustration in specific terms for the purpose of describing these forms of the invention fully and amply for one of average skill in the pertinent art, it should be understood that various substitutions and modifications which bring about substantially equivalent or superior results and/or performance are deemed to be within the scope and spirit of the following claims.

What is claimed is:

1. A cooking pad capable of absorbing cooking fluids wherein the cooking pad has a top and a bottom, a thickness, and comprises an absorbent layer that has a top and bottom and forms a three dimensional configuration comprised of one or more peaks and valleys, and wherein a height of the three dimensional configuration, measured by a distance from one peak to the bottom of the cooking pad, is greater than the thickness of the cooking pad.

2. The pad of claim 1, wherein the height of the three dimensional surface configuration is at least about a ⅝ inch.

3. The pad of claim 1, wherein a valley has a depth, measured by the distance between one peak and its adjoining valley, and the depth of the valley is greater than the thickness of the cooking pad.

4. The pad of claim 1, wherein a surface distance from a peak to another peak in the three dimensional configuration is greater than 1.0 inch.

5. The pad of claim 1, further comprising a non-stick layer attached to the top of the absorbent layer.

6. The pad of claim 1, further comprising a substantially liquid impermeable layer attached to the bottom of the absorbent pad.

7. The pad of claim 1, wherein the absorbent layer adopts the three dimensional configuration in response to a cooking environment.

8. The pad of claim 7, wherein the absorbent layer buckles when adopting a three dimensional configuration.

9. The pad of claim 7, wherein cooking is performed within a microwave oven.

10. The pad of claim 1, wherein the peaks and valleys of the three dimensional configuration extend in one direction.

11. The pad of claim 1, wherein the peaks and valleys of the three dimensional surface configuration extend in two directions.

12. The pad of claim 1, wherein the absorbent layer is comprised of cellulosic material.

13. The pad of claim 1, wherein the absorbent layer is comprised of polymeric material.

14. A cooking pad that transitions from a substantially flat configuration to a three dimensional configuration wherein the cooking pad has a top and a bottom, a thickness, and comprises a substantially flat layer that has a top and bottom, a dimensionally alterable member attached to the substantially flat layer, wherein the dimensionally alterable member alters its dimensions upon cooking such that the substantially flat layer forms a three dimensional configuration comprised of one or more peaks and valleys.

15. The cooking pad of claim 14, wherein the dimensionally alterable member is attached to the top of the layer.

16. The cooking pad of claim 15, wherein a food is placed on top of the dimensionally alterable member.

17. The cooking pad of claim 16, wherein when the substantially flat layer assumes the three dimensional configuration the dimensionally alterable member only has discreet lines of contact with the food.

18. The cooking pad of claim 16, wherein when the substantially flat layer assumes the three dimensional configuration the dimensionally alterable member only has discreet points of contact with the food.

19. The cooking pad of claim 15, wherein the dimensionally alterable member is a web or net.

20. The cooking pad of claim 15, wherein the food is suspended above the layer by the dimensionally alterable member.
